(19) United States
(12) Patent Application Publication
(10) Pub. No.: US 2010/0276961 A1
(43) Pub. Date: Nov. 4, 2010

(54) Golf cart side curtain assembly

(76) Inventor: Maurice Sydney Haagenson, Troutdale, OR (US)

Correspondence Address: Mark S. Hubert, 2300 SW First Avenue, Suite 101, Portland, OR, 97201, US

(21) Appl. No.: 12/387,271

(22) Filed: Apr. 29, 2009

(51) Int. Cl. B60J 11/06; A47H 1/022; F16B 13/14

(52) U.S. Cl. 296/83; 16/2.1

(57) ABSTRACT

A portable golf cart curtain assembly that is able to be installed by one golfer in a matter of minutes on any golf cart and provide a substantial barrier to the elements. Its extensible framework is designed to remain place despite the twisting of the golf cart frame and any jostling of the golf cart as it traverses about the course. A set of rubber grommets keeps any movement of the assembly quiet as metal on metal contact is eliminated.

### BACKGROUND OF THE INVENTION

The present invention relates to an extremely versatile portable side curtain system for a golf cart (or similarly sized utility vehicle) that is adapted to provide protection from the outside elements and ease of installation for the user. More particularly, to a universal golf cart side curtain assembly that is quiet and is designed to stay in place despite the twisting of the golf cart frame as it traverses over a golf course terrain.

Ardent golfers shoot a round of golf despite the wind and rain. Additionally, most ardent golfers own their own golf carts or rent a golf cart each time they shoot a round of golf. One way to mitigate the elements while on the course is to enclose the golf cart sides with fabric curtains. These curtains have special requirements in that they will receive little attention. They must be mildew proof, waterproof, strong enough to withstand a direct hit from a golfball, partially transparent, rigid enough to prevent being blown into the cart in a cross breeze and designed so as to allow quick access and entry.

Conventional curtains have been available on golf carts for years, however generally they zipper, snap or hook and loop fasten to close and/or attach to the golf cart. This is time consuming and frustrating at best for the user. Secondly, the present golf cart curtains on the market now are very bulky which makes them problematic to take home when they are wet. Hence the reason for such lackluster sales and poor market presence.

Henceforth, a universal golf cart side curtain that could quickly be installed on a rented golf cart would fulfill a long felt need in the golf industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a portable, universal golf cart curtain that is able to be installed by one golfer in a matter of minutes on any golf cart and provide a substantial barrier to the elements.

It has many of the advantages mentioned heretofore and many novel features that result in a new golf cart curtain assembly which is not anticipated, rendered obvious, suggested, or even implied by any of the prior art, either alone or in any combination thereof.

In accordance with the invention, an object of the present invention is to provide an improved golf cart curtain assembly that is portable and easily transportable.

It is another object of this invention to provide an improved golf cart curtain assembly capable of protecting the passengers in a golf cart from stray golf balls.

It is a further object of this invention to provide an improved golf cart curtain assembly that can be quickly installed on any golf cart and does not impede the driver's visibility.

It is still a further object of this invention to provide for an improved golf cart curtain assembly that can easily be opened and closed and is not susceptible to being blown into the cabin of the golf cart.

It is yet a further object of this invention to provide improved golf cart curtain assembly that is waterproof and resists mold and mildew accumulation as well as damage from golf balls.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is an exterior front view of the curtain;

FIG. 2 is a side view of the curtain;

FIG. 3 is an interior back view of the curtain;

FIG. 4 is a top view of the curtain rod;

FIG. 5 is cross sectional view of the curtain rod taken through the hanger slot;

FIG. 6 is a top view of the hanger bracket;

FIG. 7 is a side view of the hanger bracket;

FIG. 8 is a top perspective view of the golf cart side curtain assembly cane showing the general arrangement of all components;

FIG. 9 is a side view of the hanger brackets and telescoping curtain rod;

FIG. 10 is a perspective view of a golf cart with the hanger brackets installed;

FIG. 11 is a perspective view of a golf cart with a side curtain assembly showing a partially open curtain;

FIG. 12 is a perspective view of a golf cart with a side curtain assembly showing a fully drawn curtain; and

FIG. 13 is a perspective view of a second embodiment hanger bracket.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto. The golf cart side curtain apparatus that is described in detail below, is easy to transport as well as remove and install by one person, on any golf cart. It is also mildew and mold resistant, waterproof and windproof.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

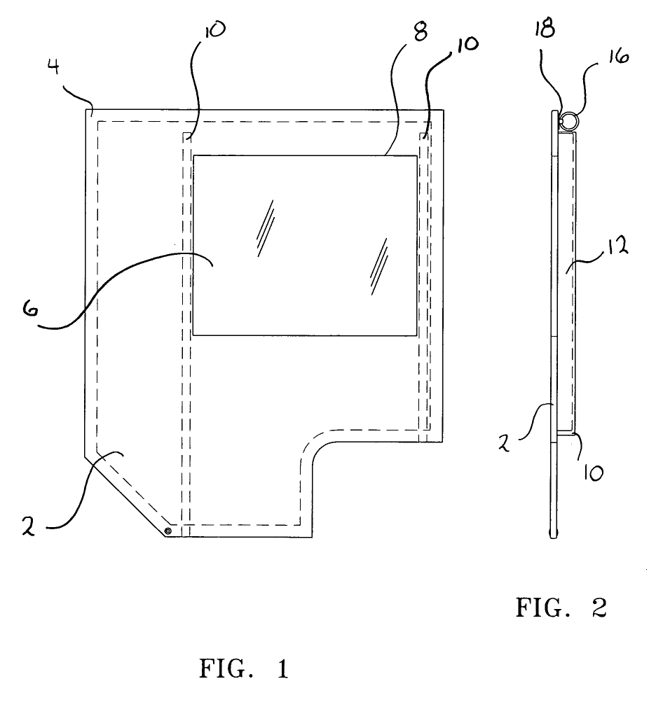

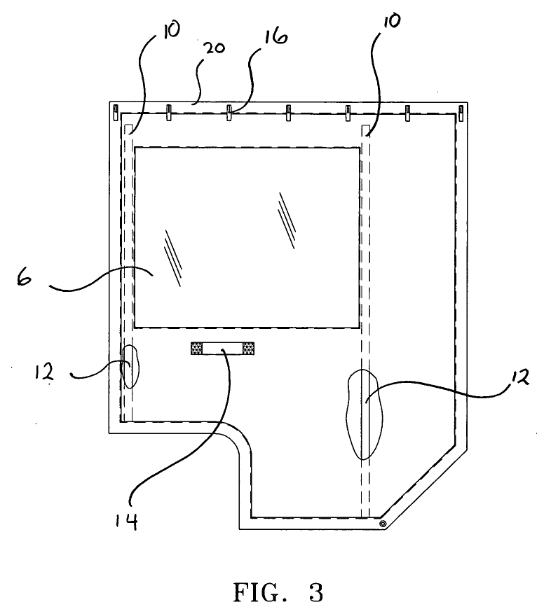

Looking at FIGS. 1, 2 and 3 it can be seen that the side curtain 2 is made of a waterproof flexible cloth with the peripheral edges 4 stitch hemmed back onto the body of the curtain. Preferably the curtain material is treated so as to prevent mildew and mold from forming on it surfaces. A transparent plastic window 6 is constrained into a central cutout 8 in the main curtain body. Two parallel linear fabric sleeves 10 are vertically sewn onto the curtain 2 on either side of the window 6. The bottom of each sleeve is stitched shut. Into these sleeves 10 are weighted rods 12. These rods serve to hold the curtain 2 draped in a generally planar vertical configuration. This prevents the curtain 2 from being blown onto or sucked onto the driver and passengers as well as adding mass to the curtain 2 to prevent a stray golf ball from transferring its energy through the curtain to the passengers. Hollow steel pipe/tubing has been shown to work well. A fabric handle 14 is sewn to the interior side of the curtain 2 to allow the opening and closing of the curtain 2. Fabric loops 18 are stitched about the upper hem 20 so as to constrain rings 16 although other ring retention means may be used such as hook and loop fasteners, dome fasteners or zig zag stitching. The rings are of a resilient, non rusting material such as stainless steel, brass, or a polymer that slidingly engage the telescoping curtain rod 22.

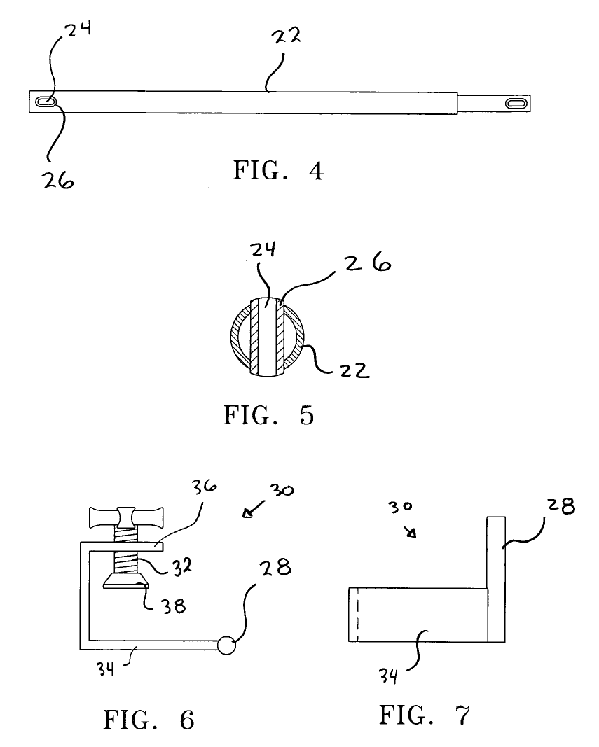

Looking at FIGS. 4 and 5 the telescoping curtain rod 22 can best be seen. Basically the curtain rod 22 is made of a first section of piping that is slide inside a second, larger section of piping with a suitable clearance between the OD of the first section of piping and the ID of the second section of piping so as to minimize slop yet allow smooth sliding engagement between the two. This sliding engagement allows the curtain rod 22 to lengthen and shorten as need be as the golf cart frame twists. There are also substantial length differences between the pillars on the various types of golf carts and this telescoping rod 22 allows the side curtain assembly to generically fit all golf carts. The distal and proximate ends of the curtain rod 22 each have oblong orifices 24 cut therethrough the piping that reside along the linear axis of the piping. A polymer bushing 26 is fit about the interior of these oblong orifices 24. This bushing 26 helps to frictionally engage peg 28 as well as silence any metal to metal contact that occurs between the peg 28 and the curtain rod 22 as the golf cart jostles about.

FIGS. 6 and 7 show the curtain rod support 30. This support 30 is made up of a “J” shaped body having a threaded bore on the short “J” arm 36, housing a conventional spindle assembly 32 that threadingly engages inwardly toward the Long “J” arm 34 and a circular peg 28 that extends normally from the end of the long “J” arm 34. The spindle assembly has a retaining pad 38 affixed to its bottom end. Although not shown, there are optional polymer, non marking semi compressible pads that may be affixed to the retaining pad and the inside of the long “J” arm 34 to prevent scratching the golf cart pillars 40. It is well known in the industry that other means of compression may be used in conjunction with the curtain rod support 30 such as circular clamps, buckle clamps and the like.

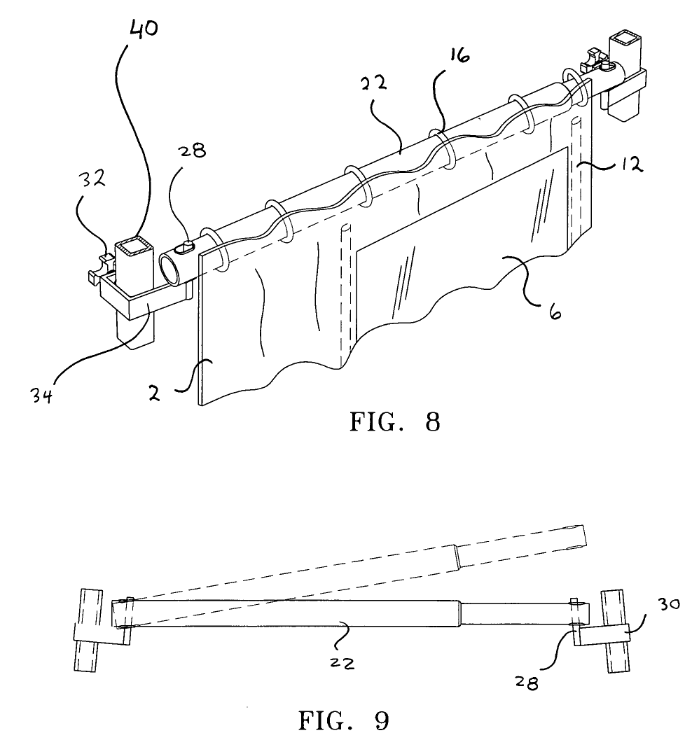

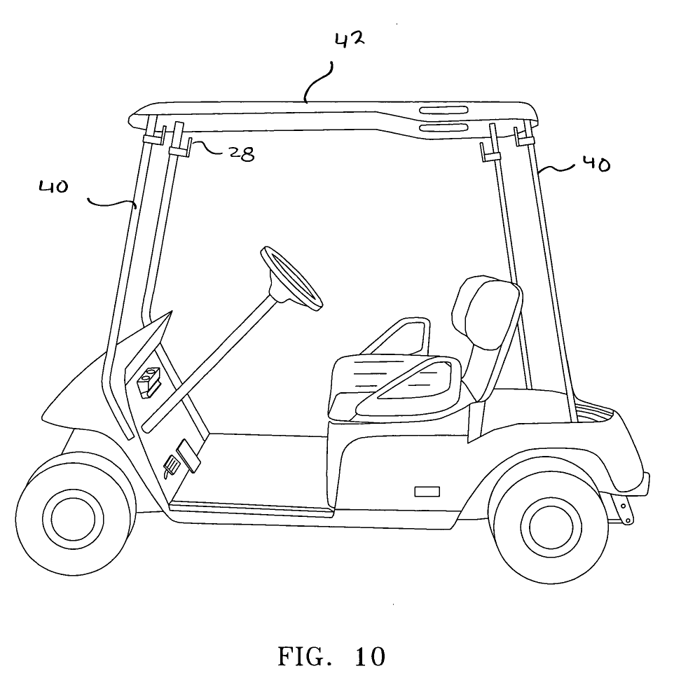

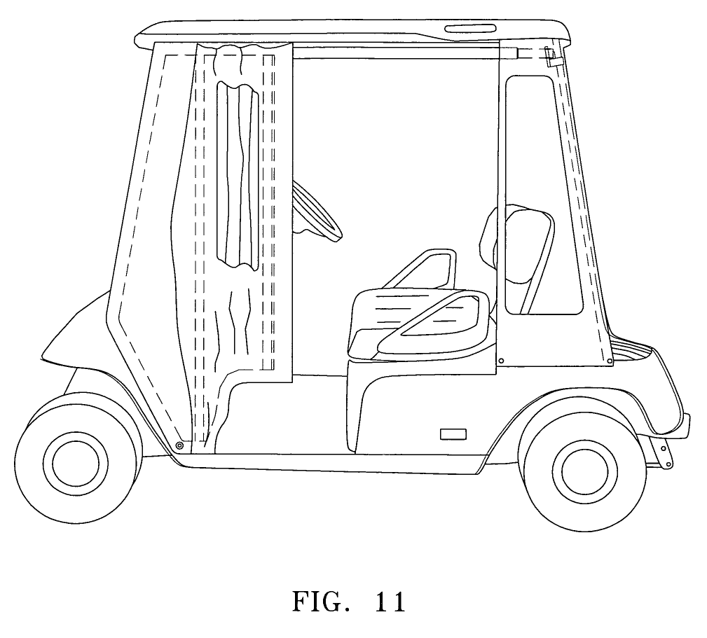

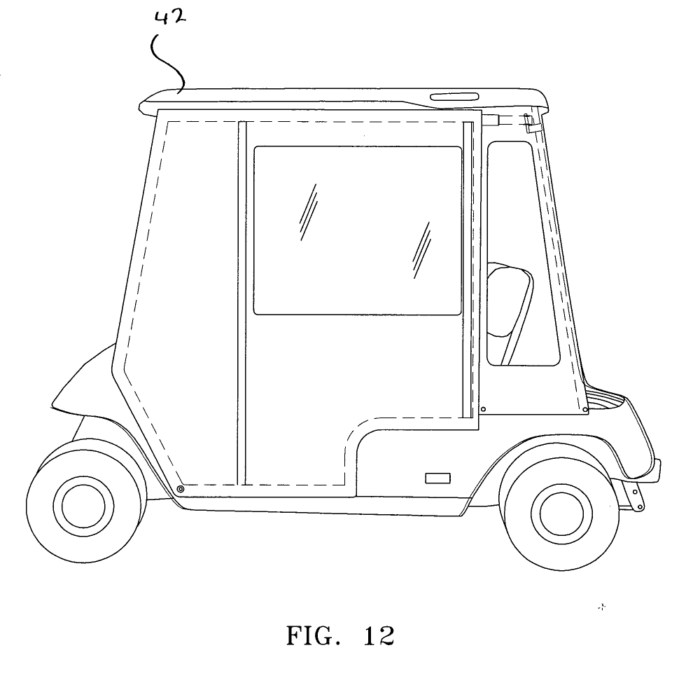

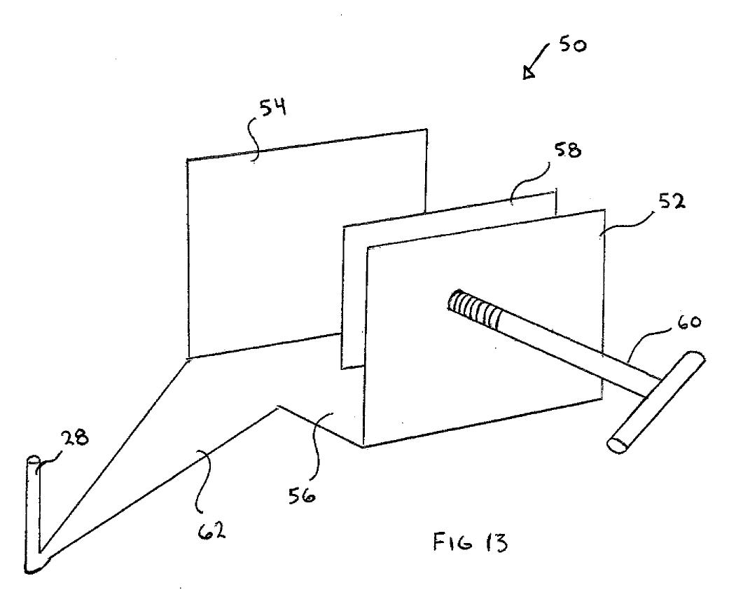

FIG. 8 shows how the entire golf cart side curtain assembly is attached to the golf cart 42. The curtain rod support 30 is placed about the upper end of the golf cart pillar 40 adjacent the golf cart roof such that the peg 28 resides inside the compartment of the golf cart 42. The spindle 32 is twisted clockwise until the long “J” arm 34 and the retaining pad 38 firmly grip the pillar 40. The remaining curtain rod supports are affixed to the remaining golf cart pillars 40 at the approximate elevation of the first one. (Ref FIG. 10) The weighted rods 12 are slid to the bottom of the sleeves 10 and the curtain rod 22 is extended and feed through all of the curtain rings 16. The curtain rod/curtain assembly is lifted and the pegs 28 is inserted through oblong orifices 24 with their bushings 28 so as to constrain and support the curtain rod 30 at their distal and proximate ends.(Ref FIG. 9) Theoretically this should leave the curtain rod 22 residing parallel to the ground and the roof of the gold cart although different golf carts may have a slightly different orientation.

The curtain 2 may now be slid to the front of the golf cart 42 to allow the passengers to exit as in FIG. 11 or may be slid to the rear of the golf cart 42 to protect the passengers from the elements and stray golf balls. There is clearance space about the pegs 28 within the oblong orifices 24 that allow for the slight cart frame twisting without moving the curtain rod 22 and curtain 2.

The use of the golf cart side curtain assembly is universal for all golf carts despite the dimensions between the golf cart pillars, because of its telescoping curtain rod 22. In a longer body golf cart the curtain 2 may not extend to cover the entire side opening, however, it will be slid forward to the front end of the rod 22 and will extend far enough rearward to ensure the passengers do not experience any rain upon them. The curtain may be attached at the front to the golf cart pillars by a set of ties (not illustrated) that are nothing more than strings or hook and loop fasteners affixed to the inner and outer sides of the curtain 2 about the peripheral edge. When the curtain 2 does get wet it may be hung to dry.

There are several variations in cart designs the newer ones of which do not utilize stanchions or support pillars at the four corners of the roof, rather, the rear pillars 40 are positioned closer together toward the centerline of the roof. In this situation there is an alternate embodiment curtain rod support 50 (FIG. 13) that connects to these pillars 40 but has an extension that moves the peg 28 to the outside of the cart. The alternate embodiment curtain rod support 50 is a vice style clamping body. It is a “U” shaped body having a first planar side 54 and a second planar side 52 held in a parallel configuration by a third side 56, and a clamping face 58 which is capable of being advanced toward the first planar side 54 by the rotation of a screw mechanism 60 which is rotatably attached to the clamping face 58 and also threadably engaged through a threaded bore formed through said second planar side 52. The third side 56 has an extension 62 projecting therefrom and a peg 28 that extends from said third side. This configuration ensures the peg 28 will be located toward the outside of the cart roof rather than near the cart roof centerline. This allows the curtain rod 22 to hang in the same position as discussed above.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A golf cart side curtain assembly comprising:
at least one linear expandable, telescoping curtain rod having a distal end and a proximate end, each with an adjacent, oblong orifice formed there through and residing perpendicular to a linear axis of said curtain rod;
at least one flexible fabric curtain having at least one pocket sewn thereon a side thereof said curtain and wherein said curtain has a top edge, a bottom edge and two side edges;
at least one weighted rod residing in said pocket;
at least two curtain ring retention means affixed adjacently along said curtain top edge;
at least two curtain rings constrained by said retention means; and
at least two curtain rod supports made up of a “J” shaped body having a short arm held parallel to a long arm by a connecting member, wherein a threaded bore formed through said short arm houses a spindle that threadingly engages inwardly toward the long arm, and a circular peg that extends therefrom said long arm and supports said curtain rod by projecting through said oblong orifices.

2. The golf cart side curtain assembly of claim 1 wherein said curtain rings are of a planar, round configuration.

3. The golf cart side curtain assembly of claim 1 wherein said curtain rod is of a hollow tubular configuration having a first section with an inner diameter and a second section with an outer diameter that is dimensionally smaller than said first section's inner diameter to as to allow the sliding engagement of said second curtain rod within said first curtain rod.

4. The golf cart side curtain assembly of claim 1 further comprising at least two polymer bushings sized to frictionally fit around an inner perimeter of said oblong orifices.

5. The golf cart side curtain assembly of claim 1 wherein the number of pockets is two and each pocket resides parallel to the other.

6. The golf cart side curtain assembly of claim 1 further comprising a clear fabric window affixed about a peripheral edge of a cutout section of said curtain.

7. The golf cart side curtain assembly of claim 1 wherein said spindle assembly has a distal end with a handle thereon and a proximate end with a retaining pad thereon.

8. The golf cart side curtain assembly of claim 1 wherein said curtain has peripheral hems stitched onto said top edge, bottom edge and side edges.

9. The golf cart side curtain assembly of claim 4 further comprising at least two polymer bushings sized to frictionally fit around an inner perimeter of said oblong orifices.

10. The golf cart side curtain assembly of claim 9 wherein the number of pockets is two and each pocket resides parallel to the other.

11. The golf cart side curtain assembly of claim 10 further comprising a clear fabric window affixed about a peripheral edge of a cutout section of said curtain.

12. The golf cart side curtain assembly of claim 11 wherein said spindle assembly has a distal end with a handle thereon and a proximate end with a retaining pad thereon.

13. The golf cart side curtain assembly of claim 12 wherein said curtain has peripheral hems stitched onto said top edge, bottom edge and side edges.

14. The golf cart side curtain assembly of claim 13 wherein said curtain rings are of a planar, round configuration.

15. A golf cart side curtain assembly comprising:
two linear expandable, telescoping curtain rods each having a distal end and a proximate end, each end with an adjacent, oblong orifice formed there through and residing perpendicular to a linear axis of said curtain rod;
an oblong polymer bushing frictionally engaged into said oblong orifices;
two flexible fabric curtains each having at least two linear pockets sewn thereon said curtain and wherein said curtains have a top edge, a bottom edge and two side edges and a clear fabric window affixed about a peripheral edge of a cutout section of each said curtain;
at least four weighted rods residing in said pockets;
at least four curtain ring retention means affixed adjacently along said each curtain's top edge;
at least eight round, planar, curtain rings constrained by said retention means; and
four curtain rod supports each made up of a “J” shaped body having a short arm held parallel to a long arm by a connecting member, wherein a threaded bore formed through said short arm houses a spindle that threadingly engages inwardly toward the long arm, and a circular peg that extends therefrom said long arm and supports said curtain rod by projecting through said oblong orifices.

16. A golf cart side curtain assembly comprising:
at least one linear expandable, telescoping curtain rod having a distal end and a proximate end, each with an adjacent, oblong orifice formed there through and residing perpendicular to a linear axis of said curtain rod;
at least one flexible fabric curtain having at least one pocket sewn thereon a side thereof said curtain and wherein said curtain has a top edge, a bottom edge and two side edges;
at least one weighted rod residing in said pocket;
at least two curtain ring retention means affixed adjacently along said curtain top edge;
at least two curtain rings constrained by said retention means; and
at least two curtain rod supports made up of a clamping body having a circular peg projecting therefrom to support said curtain rod by projecting through said oblong orifices.

16. The golf cart side curtain assembly of claim 15 wherein said clamping body is a “U” shaped body having a first planar side and a second planar side held in a parallel configuration by a third side, a clamping face capable of being advanced toward said first planar side by the rotation of a screw mechanism rotatable attached to said clamping face and threadably engaged through a threaded bore formed through said second planar side, and wherein said peg extends from said third side.

17. The golf cart side curtain assembly of claim 16 wherein said third side has a projection extending therefrom upon which said peg is affixed.
